(19) United States
(12) Patent Application Publication
(10) Pub. No.: US 2026/0288780 A1
(43) Pub. Date: Sep. 24, 2026

(54) APPLICATION-SPECIFIC DATA COLLECTION AND DIGITAL ASSISTANT LEVERAGING LLM CAPABILITIES

(71) Applicant: SAP SE, Walldorf (DE)

(72) Inventors: Chandan GURAV, Downingtown, PA (US); Kiran BOSE, Princeton, NJ (US); Mikhail KITSIKAU, Warsaw (PL); Jan MUSIL, Coopersburg, PA (US); Dmytro KOLESNYKOV, Kyiv (UA)

(21) Appl. No.: 19/202,545

(22) Filed: May 8, 2025

Related U.S. Application Data
(60) Provisional application No. 63/775,460, filed on Mar. 21, 2025.

(51) Int. Cl. G06F 16/3329; G06F 16/383

(52) U.S. Cl. CPC G06F 16/3329; G06F 16/383

(57) ABSTRACT

System, method, and various embodiments for an application-specific digital assistant system are described herein. An embodiment operates by receiving a request from a user regarding usage of a first application. One or more data retrieval tools (DRTs) associated with generating an response to the request execute against a plurality of document. The one or more DRTs are configured to identify a subset of documents that are related to the request and generate a rank of at least a portion of documents from the subset of documents based on relative importance in generating an response to the request. A response prompt is generated for instructing a large language model (LLM) to generate the response to the request based on the subset of documents and the rank. The response to the request is provided to the user.

### CROSS-REFERENCE TO RELATED APPLICATIONS

This application claims priority to U.S. Provisional Application 63/775,460, titled “Application-Specific Data Collection And Digital Assistant Leveraging LLM Capabilities,” filed Mar. 21, 2025, which is hereby incorporated by reference in its entirety.

### BACKGROUND

Installing and configuring new software applications can be a complicated process, which often raises questions by users who need help. It is not uncommon for a user to have questions about different settings or how to perform various tasks in the installation, configuration, or even usage of the application. User manuals are limited in what they can provide, are static (such that they will not account for updates), and require the user to perform tedious and manual searches for what they are looking for. A manual helpdesk is both expensive to maintain, and subject to human error. Further, every time there is a software update, the helpdesk personnel would have to be retrained on the update which may delay the rollout of the update.

### BRIEF DESCRIPTION OF THE DRAWINGS

The accompanying drawings are incorporated herein and form a part of the specification.

FIG. 1 is a block diagram illustrating example functionality for an application-specific digital assistant system (ASD), according to some embodiments.

FIG. 2 is a flowchart illustrating example operations for generating a response to a request by the application-specific digital assistant system (ASD), according to some embodiments.

FIG. 3 is a flowchart illustrating example operations for providing an application-specific digital assistant system (ASD), according to some embodiments.

FIG. 4 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing an application-specific data collection and digital assistant system leveraging LLM capabilities.

Installing and configuring new software applications can be a complicated process, which often raises questions by users who need help. It is not uncommon for a user to have questions about different settings or how to perform various tasks in the installation, configuration, or even usage of the application. User manuals are limited in what they can provide, are static (such that they will not account for updates), and require the user to perform tedious and manual searches for what they are looking for. A manual helpdesk is both expensive to maintain, and subject to human error. Further, every time there is a software update, the helpdesk personnel would have to be retrained on the update which may delay the rollout of the update.

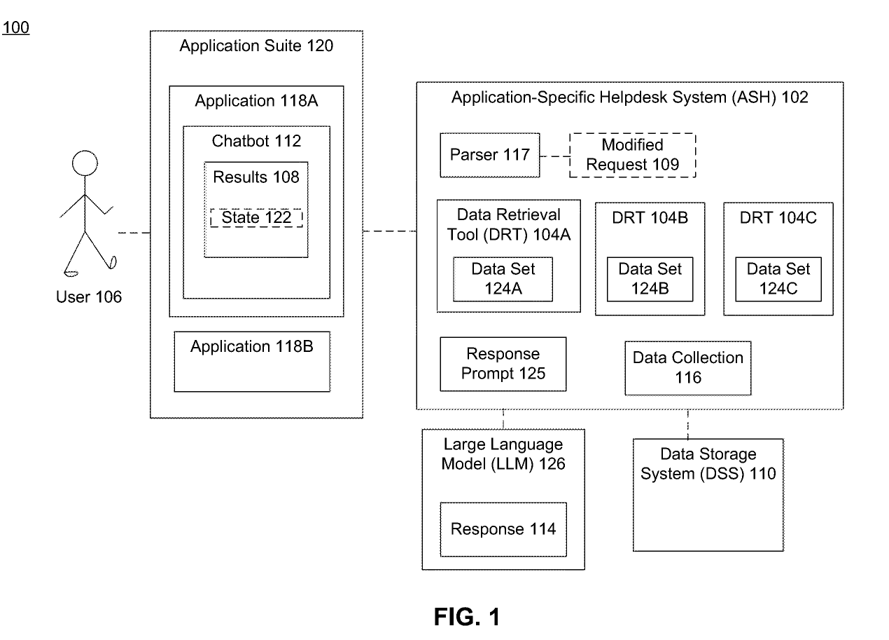

FIG. 1 is a block diagram 100 illustrating example functionality for an application-specific digital assistant system (ASD) 102, according to some embodiments. ASD 102 may function as a digital assistant, receiving questions (e.g., requests 108) from users 106 who are installing, configuring, or otherwise using one or more applications 118A, 118B of an application suite 120, and generating answers to those questions.

ASD 102 may leverage the use of a large language model (LLM) 126. However, unlike conventional LLMs, ASD 102 may include or utilize one or more specialized data retrieval tools (DRTs) 104A-C (referred to herein generally as DRT 104 or DRTs 104) each of which identifies and retrieves a subset of data (e.g., data set 124A-C) from a data storage system (DSS) 110 that is relevant to generating a response 114 to the request 108. In some embodiments, the DRTs 104 may include artificial intelligence (AI) assistants that help identify relevant data. These data sets 124A-C (referred to herein generally as data set 124) may be aggregated into a data collection 116, which may then be provided by and used by LLM 126 to generate the response 114. In some embodiments, LLM 126 may be restricted to either primarily or only using information from data collection 116 in generating response 114. In some embodiments, LLM 126 may be instructed to weigh the data from data collection 116 more heavily than any other information retrieved from any other data source.

ASD 102 may provide various computational and practical advantages over a conventional LLM system. For example, collecting request-specific data for LLM 126, as data collection 116, which LLM 126 then relies upon in generating response 114, provides a more accurate response 114 to user 106, which results in fewer requests from a user trying to find the right answer, and thus fewer processing resources being consumed in answering a user query. This provides a significant advantage over conventional LLMs, which are general and rely on a massive corpus of data, most of which is irrelevant to any one particular request or query. This inclusion and reliance upon unrelated data, in a conventional LLM. can often result in producing an answer that is unrelated to the user query or request 108. Further, focusing on only a smaller and specific data collection 116, rather than a much larger general corpus of data, inherently has processing speed benefits, in that less data needs to be parsed by LLM 126 in generating a more accurate answer or response 114.

In some embodiments, a user 106 may be installing, configuring, or otherwise operating an application 118A. In some embodiments, application 118A may be part of an application suite 120 including multiple different applications 118A, 118B (referred to herein generally as application 118). The applications 118 may be accessible from a shared interface or portal, or may each have their own separate interface. In some embodiments, the various application 118 of application suite 120 may all be developed by the same company or organization, or be compatible with the same operating system or interface. In some embodiments, the application 118 may include web applications that are accessible from the same portal or homepage.

In some embodiments, user 106 may have a question about the installation, configuration, and/or operation of a particular application 118A. Rather than manually searching through a printed or previously generated manual, which may be outdated and difficult to navigate to find an answer to the user’s question, or trying to call a general helpdesk line which may not be available at various days/times, and limited by the experiences of the personnel who answers the call, the user 106 may submit their question to ASD 102 as a request 108.

In some embodiments, ASD 102 may provide the user 106 with the option of interacting with, and submitting request 108 to a chatbot 112. Chatbot 112 may include a computer program that is designed to simulate a conversation with a human user. Chatbot 112 may include any interface that enables a user 106 to access chatbot functionality or interact with a chatbot. In some embodiments, chatbot 112 may be accessible via the internet (e.g., through a website), a messaging application (including textual and/or audio communications), or any add on messaging service that enables two-way communications. Chatbot 112 may allow user 106 to speak and/or type input, such as request 108. Chatbot 112 may provide a response 114 in audio, text, or multimedia format, including hyperlinks.

In some embodiments, chatbot 112 may be trained to respond to particular user inputs, based on identifying particular keywords. In some embodiments, chatbot 112 may perform initial NLP (natural language processing) on the request 108 (or other user input). For example, request 108 may include a natural-language input from user 106 such as “What is the next step in the installation process for this application I am using?”

In some embodiments, chatbot 112 may be accessible as part of application suite 120, even while user is installing or configuring a particular application 118 of application suite 120. In some embodiments, each application 118 may have its own chatbot 112.

In some embodiments, chatbot 112 may generate or retrieve a state 122 associated with the request 108. The state 122 may include any data that is accessible about application 118, application suite 120, and/or the interactions of user 106 prior to the receipt of request 108. In some embodiments, state 122 may identify the application 118A through which the request 108 was received, or the most recently used application 118. In some embodiments, state 122 may be able to identify where in the installation or configuration process or roadmap a user currently is (e.g., what steps were most recently completed successfully and/or attempted). In some embodiments, chatbot 112 may query application 118A, which may include an installation/configuration log or manager, to retrieve state 122. In some embodiments, state 122 may be a copy of a log file maintained by application 118 or application suite 120.

In some embodiments, state 122 may include information about multiple applications 118 or about an application different from the application 118A through which the request 108 was receive. For example, user 106 may be using application 118A but enter a request 108 about application 118B. Chatbot 112 may search request 108 (e.g., for keywords), identify that a reference is made to application 118B, and retrieve the state 122 of application 118B and submit that state 122 with the request 108. In some embodiments, the state 122 may include information about both application 118A (from which the request 108 was received) and the application 118B that may be referenced in the request 108.

In some embodiments, the state 122 may include which step of the installation / configuration process was previously completed or which is currently active, what was the last file opened or created with application 118, the name of a previously saved file, the username of the user 106, the type of device being used, version number(s), the update being installed, or other information. In some embodiments, state 122 may be retrieved from metadata or a file, such as a log, written to by an application 118 during an installation, configuration, or usage of the application 118.

In some embodiments, chatbot 112 may provide request 108 (and state 122) to a parser 117. Parser 117 may parse the submitted request 108 for a set of keywords or other context on what user 106 is asking. In some embodiments, parser 117 may include a language model or other natural language processing capabilities, such that parser 117 may ‘understand’ what the user 106 is asking. Based on this initial processing by parser 117, and the information retrieved from state 122, ASD 102 may launch or distribute request 108 and/or state 122 information to one or more DRTs 104.

In some embodiments, each DRT (data retrieval tool) 104 may be specialized or configured to identify and retrieve a particular portion of data from a data storage state (DSS) 110. Such that, in processing a single request 108, ASD 102 may launch multiple DRTs 104, which may themselves launch other DRTs 104 as well. As described in greater detail below, each DRT 104 104A-C will retrieve or return a corresponding data set 124A-C, which may be combined into a data collection 116 for answering or generating a response 114 to request 108. In some embodiments, a DRT 104 may rank or weigh the data is identified and retrieved as part of its data set 124.

In some embodiments, DSS 110 may include one or more data storage devices or mechanisms where documents related to the installation, configuration, and/or usage of the applications 118 of application suite 120 are stored. In some embodiments, DSS 110 may include a database, library, and/or other collection of files. In some embodiments, DSS 110 may exclude any documents or files that are not related to the applications 118 of application suite 120, thereby producing a smaller data storage mechanism which is faster to search and produces more accurate results.

In some embodiments, DSS 110 may limit which person(s) or organization(s) may contribute files or data that is to be stored in DSS 110. For example, DSS 110 may limit contributions to only those individuals who are listed as developers, creators, or managers of a portion of application suite 120. In some embodiments, when a new file is added to DSS 110, ASD 102 (e.g., via parser 117) may perform a check for keywords or other check to ensure that the content of the new file is related to one or more of the applications 118. If ASD 102 determines that the file is not related to application suite 120, then the file may be rejected or stored in a general repository, but may be excluded from DSS 110. In some embodiments, ASD 102 may generate a new file prompt and provide the new file to LLM 126 to determine if the new file is related to application suite 120.

In some embodiments, parser 117 may be an LLM-based agent that calls the various DRTs 104. Each DRT 104 may be configured to parse at least a portion of DSS 110, and identify and extract a data set 124 that is related to request 108. As noted above, each DRT 104 may be configured to perform a specialized data identification and/or retrieval task, and multiple DRTs 104 may operate simultaneously or in parallel without interfering with each other. Some example DRTs 104 are described below.

In some embodiments, DRTs 104 may include an entity retrieval tool. The entity retrieval tool may perform various functions with regards to identifying relevant documents or entities that may be useful in generating response 114. For example, entity retrieval tool may retrieve a chat history between user 106 and chatbot 112. Using this chat history context, entity retrieval tool or parser 117 may rephrase the request 108, replacing certain words in request 108 with more clearer words or phrases, and even removing extraneous words that do not impact the query, generating a modified request 109. For example, the request 108 may be “I want to know what is the next step in installing CustomerSoftvare”. ASD 102 may rephrase this request 108 to be “What is the next step in installing CustomerSoftware”, removing extraneous words and correcting the spelling of the software package, as modified request 109.

In some embodiments, entity retrieval tool may identify the top 15 (or other number of documents) from DSS 110 corresponding to the modified request 109. In some embodiments, entity retrieval tool may rank the various documents based on closeness or similarity to the modified request 109. In some embodiments, state 122 may be used to limit those documents which are evaluated by entity retrieval tool. For example, if state 122 indicates that request 108 is related to application 118A, then entity retrieval tool may only evaluate documents from DSS 110 tagged or identified as being related to application 118A, while ignoring documents related to application 118B. Or, if state 122 indicates that the request 108 is related to installation of application 118A, then documents related to the usage of application 118A (after installation) may be excluded from the evaluation by entity retrieval tool, thus improving overall system throughput.

In some embodiments, the entity retrieval tool, may make a call to another DRT 104 as part of its execution. For example, entity retrieval tool may make a call to a roadmap tool (which may be another example DRT 104). The roadmap tool may fetch, identify, or retrieve documents from DSS 110 related to a roadmap for a particular process or task being performed by user 106.

A roadmap may be any set of steps or procedures for performing some task or operation or set of operations with respect to any application 118 of application suite 120. As an example, there may be a roadmap for the various steps that are required to be performed as part of an installation or configuration process of application 118A. And in some embodiments, an individual step of the installation process may have its own additional roadmap. As an example, the roadmap tool may identify documents related to both the general roadmap and the step-specific roadmap as part of its execution, and return these as part of its data set 124.

If the roadmap tool was called as part of the entity retrieval tool, then the identified roadmap data may be provided to entity retrieval tool, which may then rate and rank the roadmap data or documents as part of its own evaluation process, and return the most relevant documents as part of its own data set 124 (e.g., the roadmap tool may not then return a separate data set, since its identified documents were already accounted for). Or, for example, the entity retrieval tool may use the roadmap to help identify and/or rank/weigh the various documents from DSS 110 for relevance to request 108 or modified request 109.

In some embodiments, DRTs 104 may include a relationship tool. The relationship tool may identify relationships between the various entities, as identified by the entity retrieval tool. An entity may include any document related to the request 108. A relationship may include any connection between two or more entities. For example, the roadmap may indicate a flow of Steps A, B, C, and D, the request being focused on step C. The relationship tool may identify step B as being a predecessor and/or step D as being a successor. In some embodiments, the entity retrieval tool may call both the roadmap tool and the relationship tool as part of its processing or execution.

In some embodiments, steps B and D may be provided back to entity retrieval tool, which may identify and retrieve one or more documents related to steps B and D. In some embodiments, the number of documents for steps B and D may be smaller than the number of documents for step C, because steps B and D are supporting steps, while the request is focused on step C.

In some embodiments, DRTs 104 may include a link provider tool. The link provider tool may be configured to identify and/or generate links to the documents of the results generated by entity retrieval tool. In some embodiments, link provider tool may identify new documents related to the results of the entity retrieval tool and provide links (e.g., hyperlinks) to those related documents.

In some embodiments, DRTs 104 may include a golden question tool. In some embodiments, developers, designers, creators, users, or other experts of an application 118A may think of questions that a user is likely to ask about in installing, configuring, and/or using the application 118A. The expert may also provide an answer to this question. These question-answer pairs may be stored as part of DSS 110 as golden questions. In some embodiments, the golden question tool may compare the request 108 to the golden questions of DSS 110 and identify any question-answer pairs that are related to the request 108. In some embodiments, the golden question tool may rate or rank the golden questions and only return some subset of the top-most results. These question-answer pairs of golden questions may be stored as part of data collection 116.

In some embodiments, DRTs 104 may include a clarification tool. The clarification tool may interacts with user 106 through chatbot 112 (or another interface) requesting clarification for request 108. For example, request 108 may be ambiguous, may be missing information, or may need clarification for any other reason. Clarification tool may be used to request and receive any missing information, and amend or modify the request 108 accordingly. In some embodiments, clarification tool may be run prior to other DRTs 104 and run in conjunction with parser 117.

In some embodiments, one or more of the DRTs 104 may execute in parallel with one another. Because each DRT 104 is specialized and focuses on identifying, retrieving, and/or ranking different information from DSS 110, the DRTs 104 may execute in parallel, which may allow for faster retrieval and accumulation of information for data collection.

In some embodiments, data collection 116 may include one or more copies of the documents (or a subset of the documents) that are relevant to generating response 114 to request 108. In some embodiments, data collection 116 may include a list of various pointers or addresses in DSS 110 where relevant documents are stored, and from where they may be accessed and/or retrieved.

In some embodiments, ASD 102 may include a prompt generator that generates a response prompt 125 to instruct LLM 126 to generate a response 114 to request 108 based on data collection 116. A prompt, such as response prompt 125, may include one or more lines of text organized across one or more documents that is particularly formatted to be understandable by an LLM 126. LLM 126 may include an artificial intelligence, machine learning, or deep learning model that is configured to execute data processing commands from plain-text (e.g., not requiring computer language or coded input). LLM 126 may include any computing system that is configured to perform processing tasks based on text-based or plain language inputs. LLM 126 may be configured to create original content from one or more documents or input in accordance with a prompt. In some embodiments, LLM 126 may include a generative pre-training transformer (GPT). In some embodiments, LLM 126 may include any generative AI system, including, but not limited to, a transformers-based generative AI foundation model.

The response prompt 125 may include (or may include one or more references or pointers to) data collection 116. In some embodiments, response prompt 125 may include an instruction for LLM 126 to only rely on the documents or information from data collection 116 in generating response. In some embodiments, response prompt 125 may instruct LLM 126 to primarily rely on documents or information from data collection 116, such that if there is any conflicting information found by LLM 126, any conflicts will be resolved in favor of the documents of data collection 116.

In some embodiments, one or more of the DRTs 104 may also perform a ranking of the retrieved documents, indicating which ones are to be given greater weight or importance in generating the response 114. In some embodiments, response prompt 125 may include an instruction to LLM 126 to weigh or primarily rely on the highest ranked documents of data collection 116 more heavily than any other information. In some embodiments, response prompt 125 may include a percentage upon which LLM 126 is rely on the documents (or highest ranked documents) of data collection 116 relative to other information to which LLM 126 may have access (e.g., 80-20, where LLM 126 is to rely at least 80% on data collection 116, and a maximum up to 20% on other documents, either outside of data collection 116 or outside of the highest ranked documents of data collection 116).

In some embodiments, LLM 126 may be specially trained to answer questions regarding application suite 120. LLM 126 may be able to account for specific data formatting of documents in DSS 110 and/or special formatting of output, which may be helpful for a user 106 of any of the applications 118 of application suite 120. In some embodiments, these special formatting and output instructions may be included in response prompt 125.

In some embodiments, if application 118A is updated (e.g., by a system administrator) or an update is being installed for application 118, ASD 102 may be used to help a user immediately answer questions with regards to installing, configuring, and/or using the updates. For example, new documents related to the update may be submitted to the DSS 110, and may immediately be available to ASD 102 for retrieval, inclusion in data collection 116, and be used by LLM 126 in generating a response 114. This may allow for a faster rollout of updates, without needing to generate a new manual or training new helpdesk personnel. Additionally, a developer of the update may provide answers to one or more golden questions which may be used to generate a response 114 to any requests 108 related to the update.

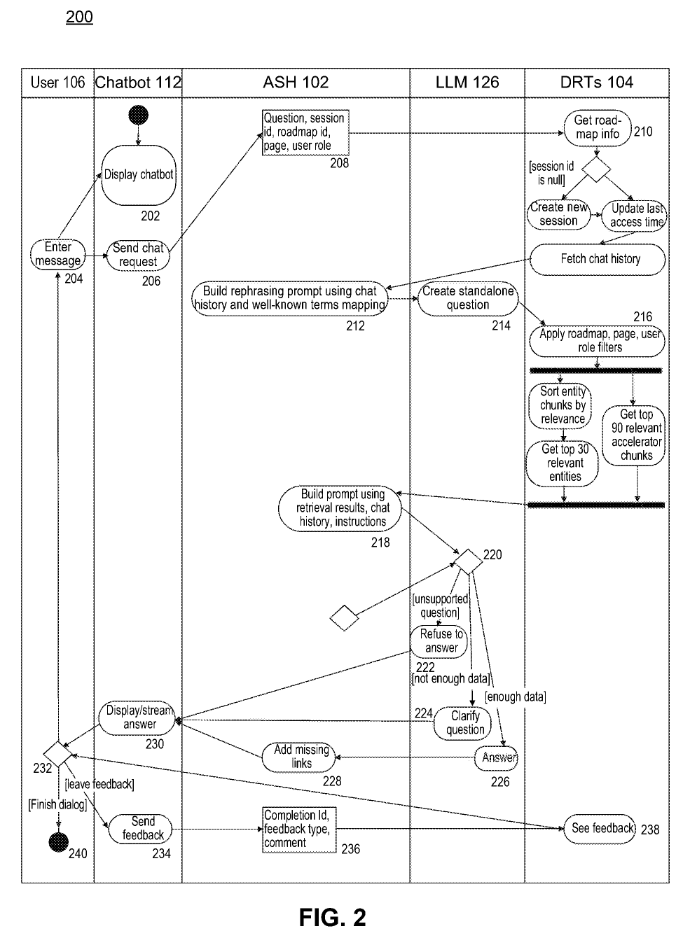

FIG. 2 is a flowchart 200 illustrating example operations for generating a response 114 to a request 108 by the application-specific digital assistant system (ASD) 102, according to some embodiments. Method 200 shall be described, in part, with reference to FIG. 1.

At 202, chatbot 112 may be displayed on a user interface of application 118A, with a null session ID. At 204, user 106 may enter a message into chatbot 112 which may be received as request 108 (at 206). In some embodiments, ASD 102, through chatbot 112 may determine a state 122 of application 118A.

At 208, ASD 102 may retrieve background information regarding the user, session, roadmap etc. At 210, ASD 102 may create a new session id (to track and store the session) and retrieve any chat history between chatbot 112 and user 106. In some embodiments, the user 106 may be prompted to enter or select a roadmap from a list of roadmaps, each roadmap corresponding to a different installation, configuration, or usage procedure of application 118A.

In some embodiments, even though the user 106 may be authenticated on the front end by the chatbot 112, the sessions may be stored anonymously. This may help protect user privacy. However, based on the roadmap (selected by the user or identified by ASD 102), and the context of query or request 108, ASD 102 my receive chat histories (which may or may not be by user 106) that are related to the request 108, and use those as described herein.

At 212, parser 117 may translate request 108 using Machine Translation DRT 104 if the user asks a question in a language other than English. In some embodiments, the Machine Translation Tool (e.g., DRT 104) may execute to request missing information from user 106 or request information to clarify ambiguities, and request 108 may be modified accordingly. At 226, the generated answer may again be translated with the Machine Translation Tool (e.g., DRT 104) in the original language in which the user asked the question. In some embodiments, the clarification tool (e.g., DRT 104) may execute to request any missing information from user 106 or request information to clarify any ambiguities, and request 108 may be modified accordingly. At 214, the modified request 109 may be generated.

At 216, parser 117 may launch one or more DRTs 104 to identify which information, documents, or data of DSS 110 is relevant to generating an answer or response 114 to request 108. The data sets 124 generated by the DRTs 104 may be combined together into a data collection 116. At 218, ASD 102 may generate response prompt 125 based on data collection 116, the chat history, the modified request 108, and using any other information or standing instructions.

At 220, LLM 126 may execute the response prompt 125 and execute to generate a response 114. At 222, in some embodiments, LLM may determine that the question or request 108 is unsupported and my refuse to answer, or generate a response that indicates the user 106 asked an invalid or out of bounds question. For example, if the question was related to sports, instead of application 118A, the question may be rejected by LLM 126. At 224, in some embodiments, LLM 126 may require further clarification and ask the user 106 for any necessary or missing information. As noted above, a clarification tool DRT 104 may be executed earlier in the process, which may minimize the likelihood of LLM 126 either rejecting the question or needing further clarification.

At 226, LLM 126 may generate an answer or response 114. In some embodiments, ASD 102 may add one or more links (e.g., as generated by link provider tool DRT 104), or in other embodiments, the links may be already included in the response 114 by LLM 126 which may have been instructed to include links as part of response prompt 125.

At 230, a result is displayed for a user 106 (e.g., via chatbot 112). At 234, the user may have the option of providing feedback as to whether the response was helpful, unhelpful, or provide additional notes. At 236, the feedback may be received by ASD 102, and at 238 the feedback may be saved for further refining one or more DRTs 104 and/or response prompt 125. At 240, the process completes.

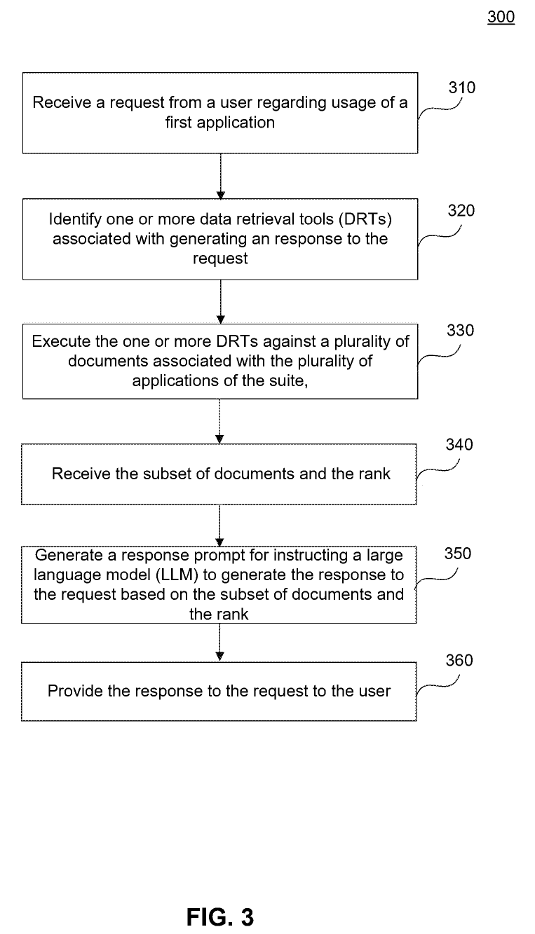

FIG. 3 is a flowchart 300 illustrating example operations for providing an application-specific digital assistant system (ASD) 102, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIG. 1.

In 310, a request is received from a user regarding usage of a first application. For example, chatbot 112 may receive a request 108 from user 106 regarding the installation, configuration, or other usage of application 118A. In some embodiments, application 118A may be part of an application suite 120 including any number of different applications 118.

In 320, one or more data retrieval tools (DRTs) associated with generating an response to the request are identified. For example, parser 117 may receive request 108 and modify request 108 (e.g., based on a chat history, and asking user for clarification via a clarification tool DRT 104). In some embodiments, parser 117 may identify and launch one or more DRTs 104, providing the modified request 108 as input. In some embodiments, a first DRT 104A may launch or execute a second DRT 104B as part of its execution.

In 330, the one or more DRTs are executed against a plurality of documents associated with the plurality of applications of the suite. For example, the DRTs 104 may execute, in parallel, DSS 110. In some embodiments, each DRT 104 may be configured to execute against a different portion of DSS 110, thus allowing for parallel execution of the DRTs 104. In some embodiments, each DRT 104 may be configured to execute against a portion of DSS 110 stored in a different computing device.

In some embodiments, the one or more DRTs 104 may each be configured to identify a data set 124 which may include a subset of documents from the DSS 110 that are related to the request. In some embodiments, a DRT 104 generate a rank or weight of at least a portion of data set 124 based on relative importance in generating a response 114 to the request 108. The weight or rank may be related to how similar the DRT 104 determines the associated document of DSS 110 to be to the (modified) request 108.

In 340, the subset of documents and the rank are receive, from the one or more DRTs. For example, ASD 102 may receive each data set 124 from the various DRTs 104. Each data set include a set of documents, which may be ranked or weighted, and which have been identified as being relevant in answering the question of request 108. In some embodiments, ASD 102 may generate a data collection 116 which includes the documents (or references, pointers, or addresses to the documents) across the data sets 124.

In 350, a response prompt for instructing a large language model (LLM) to generate the response to the request based on the subset of documents and the rank is generated. For example, ASD 102 may generate response prompt 125 which may include instructions for LLM 126 to generate a response 114 to the request 108 (or modified request, as generated by parser 117). In some embodiments, the response prompt 125 may include instructions for LLM 126 to either exclusively or more heavily rely upon the documents of data collection 116 in generating response, relative to any other outside information. And, as noted above, the documents of data collection 116 may themselves be weighted or ranked based on importance or relevance in generating response 114. This simplifies the evaluation of the documents of data collection 116 by LLM 126, and generates a faster and more accurate response 114.

In 360, the response to the request is provided to the user. For example, ASD 102 may return the response 114 to the user 106 via chatbot 112. Based on the response 114, the user 106 may then continue with their installation, configuration, and/or use of application 118A.

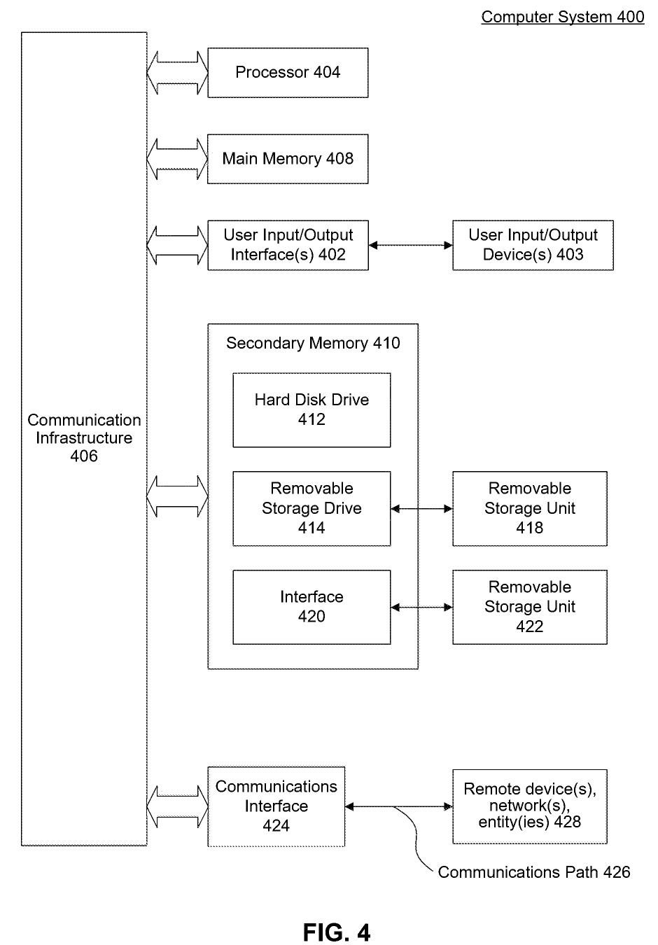

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/ any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method comprising:
receiving a request from a user regarding usage of a first application, wherein the first application is part of a suite of a plurality of applications;
identifying one or more data retrieval tools (DRTs) associated with generating an response to the request;
executing the one or more DRTs against a plurality of documents associated with the plurality of applications of the suite, wherein the one or more DRTs are configured to identify a subset of documents from the plurality of documents that are related to the request and generate a rank of at least a portion of documents from the subset of documents based on relative importance in generating an response to the request;
receiving, from the one or more DRTs, the subset of documents and the rank;
generating a response prompt for instructing a large language model (LLM) to generate the response to the request based on the subset of documents and the rank, wherein the rank indicates which documents of the subset the LLM is to rely upon more heavily in generating the response; and
providing the response to the request to the user.

2. The computer-implemented method of claim 1, wherein the one or more DRTs comprise a retrieval tool configured to identify and rank the subset of documents, and a link provider tool configured to identify links to one or more documents, wherein at least one of the links is included in the response.

3. The computer-implemented method of claim 1, wherein the one or more DRTs comprise both a first DRT and a second DRT, and wherein an execution the first DRT calls the for an execution of the second DRT.

4. The computer-implemented method of claim 1, wherein the usage comprises an installation or configuration of the first application on a computing system.

5. The computer-implemented method of claim 1, wherein a first DRT of the one or more DRTs is configured to identify a context of the request, wherein the context comprises identifying which portion of the installation or configuration process is related to the request.

6. The computer-implemented method of claim 1, wherein a first DRT of the one or more DRTs is configured to identify one or more high priority documents related to the request, wherein the one or more high priority documents are selected prior to receiving the request.

7. The computer-implemented method of claim 1, wherein the response is generated exclusively based on the subset of documents.

8. A system comprising:
a memory; and
at least one processor coupled to the memory and configured to perform operations comprising:
receiving a request from a user regarding usage of a first application, wherein the first application is part of a suite of a plurality of applications;
identifying one or more data retrieval tools (DRTs) associated with generating an response to the request;
executing the one or more DRTs against a plurality of documents associated with the plurality of applications of the suite, wherein the one or more DRTs are configured to identify a subset of documents from the plurality of documents that are related to the request and generate a rank of at least a portion of documents from the subset of documents based on relative importance in generating an response to the request;
receiving, from the one or more DRTs, the subset of documents and the rank;
generating a response prompt for instructing a large language model (LLM) to generate the response to the request based on the subset of documents and the rank, wherein the rank indicates which documents of the subset the LLM is to rely upon more heavily in generating the response; and
providing the response to the request to the user.

9. The system of claim 8, wherein the one or more DRTs comprise a retrieval tool configured to identify and rank the subset of documents, and a link provider tool configured to identify links to one or more documents, wherein at least one of the links is included in the response.

10. The system of claim 8, wherein the one or more DRTs comprise both a first DRT and a second DRT, and wherein an execution the first DRT calls the for an execution of the second DRT.

11. The system of claim 8, wherein the usage comprises an installation or configuration of the first application on a computing system.

12. The system of claim 8, wherein a first DRT of the one or more DRTs is configured to identify a context of the request, wherein the context comprises identifying which portion of the installation or configuration process is related to the request.

13. The system of claim 8, wherein a first DRT of the one or more DRTs is configured to identify one or more high priority documents related to the request, wherein the one or more high priority documents are selected prior to receiving the request.

14. The system of claim 8, wherein the response is generated exclusively based on the subset of documents.

15. A non-transitory computer-readable medium having instructions stored thereon that, when executed by at least one computing device, cause the at least one computing device to perform operations comprising:
receiving a request from a user regarding usage of a first application, wherein the first application is part of a suite of a plurality of applications;
identifying one or more data retrieval tools (DRTs) associated with generating an response to the request;
executing the one or more DRTs against a plurality of documents associated with the plurality of applications of the suite, wherein the one or more DRTs are configured to identify a subset of documents from the plurality of documents that are related to the request and generate a rank of at least a portion of documents from the subset of documents based on relative importance in generating an response to the request;
receiving, from the one or more DRTs, the subset of documents and the rank;
generating a response prompt for instructing a large language model (LLM) to generate the response to the request based on the subset of documents and the rank, wherein the rank indicates which documents of the subset the LLM is to rely upon more heavily in generating the response; and
providing the response to the request to the user.

16. The non-transitory computer-readable medium of claim 15, wherein the one or more DRTs comprise a retrieval tool configured to identify and rank the subset of documents, and a link provider tool configured to identify links to one or more documents, wherein at least one of the links is included in the response.

17. The non-transitory computer-readable medium of claim 15, wherein the one or more DRTs comprise both a first DRT and a second DRT, and wherein an execution the first DRT calls the for an execution of the second DRT.

18. The non-transitory computer-readable medium of claim 15, wherein the usage comprises an installation or configuration of the first application on a computing system.

19. The non-transitory computer-readable medium of claim 15, wherein a first DRT of the one or more DRTs is configured to identify a context of the request, wherein the context comprises identifying which portion of the installation or configuration process is related to the request.

20. The non-transitory computer-readable medium of claim 15, wherein a first DRT of the one or more DRTs is configured to identify one or more high priority documents related.
